(19) United States
(12) Patent Application Publication
(10) Pub. No.: US 2026/0244375 A1
(43) Pub. Date: Aug. 20, 2026

(54) IMAGE FORMING APPARATUS

(71) Applicant: KYOCERA DOCUMENT SOLUTIONS INC., OSAKA (JP)

(72) Inventors: WATARU KAKENO, OSAKA (JP); KUNIHIKO SHIMAMOTO, OSAKA (JP)

(21) Appl. No.: 19/533,316

(22) Filed: Feb. 9, 2026

(30) Foreign Application Priority Data
Feb. 20, 2025 (JP) 2025-025742

(51) Int. Cl. G06F 3/12

(52) U.S. Cl. CPC G06F 3/1222; G06F 3/1238; G06F 3/1239; G06F 3/1285

(57) ABSTRACT

An image forming apparatus is an image forming apparatus connected to an authentication server via a network, including a storage unit, a reception unit, and an authentication control unit. The storage unit stores at least one hot folder. The reception unit accepts a use of the image forming apparatus by the user and an access to the hot folder using user information including a user ID for identifying at least a predetermined user. The authentication control unit transmits the user information used when accessing the hot folder to the authentication server, requests authentication, and acquires job authorization information that includes authorization for at least a printing function of the image forming apparatus for the authenticated user information.

### CROSS-REFERENCE TO RELATED PATENT APPLICATION

This application claims the benefit of Japanese Priority Patent Application JP 2025-025742 filed on February 20, 2025, the entire contents of which are incorporated herein by reference.

### FIELD OF THE DISCLOSURE

The present disclosure relates to an image forming apparatus applicable to a job authorization function for a user in a multifunction printer (MFP) using user authentication.

### BACKGROUND OF THE DISCLOSURE

In the related art, there is an image forming apparatus that uses a job authorization function relating to authorization whether or not a printing function such as print, color print, or monochrome print can be used when a user logs in using network authentication.

For example, there is a known method for restricting a printing function in a printing system including a network-connected print control apparatus, a print right management server, and a printing apparatus. The method for restricting the printing function restricts the printing function by disabling selection of restricted printing function in print settings of a print job.

In addition, for example, there is a known printing system having a control means for operating a printing apparatus under printing processing conditions derived based on paper attribute information. It is provided that when a user selects paper required for printing by a printing apparatus, paper whose attribute information has not been duplicated or modified by the user is made unselectable, and paper whose attribute information has been duplicated or modified is made selectable.

Furthermore, for example, there is a known image processing apparatus including: an association means that, when communication with the image processing apparatus is established, associates an object with a driver corresponding to the image processing apparatus and a port related to communication with the image processing apparatus, and, when communication with the image processing apparatus is no longer established, disassociates the object from the driver corresponding to the image processing apparatus and the port related to communication with the image processing apparatus; and an object control means that performs control to display a first object and a second object as the same object on the display apparatus, when communication with the first image processing apparatus is established, in the association means, the first object associated with a driver corresponding to the first image processing apparatus and a port related to communication with the first image processing apparatus is displayed on a display apparatus, and, when communication with the second image processing apparatus, different from the first image processing apparatus, is established, in the association means, the second object associated with a driver corresponding to the second image processing apparatus and a port related to communication with the second image processing apparatus is displayed on the display apparatus.

Furthermore, for example, there is a known image forming apparatus terminal apparatus that sends an instruction to an image forming apparatus performing user authentication using a predetermined authentication apparatus and executing authentication print printing. It is described to accept selection of whether print output processing of a selected document data file is authentication print printing output processing or non-authentication print printing output processing.

### SUMMARY OF THE DISCLOSURE

To achieve the above object, an image forming apparatus according to one embodiment of the present disclosure is an image forming apparatus connected to an authentication server via a network, including a storage unit, a reception unit, and an authentication control unit.

The storage unit stores at least one hot folder.

The reception unit accepts a use of the image forming apparatus by the user and an access to the hot folder using user information including a user ID for identifying at least a predetermined user.

The authentication control unit transmits the user information used when accessing the hot folder to the authentication server, requests authentication, and acquires job authorization information that includes authorization for at least a printing function of the image forming apparatus for the authenticated user information.

### BRIEF DESCRIPTION OF THE DRAWINGS

FIG. 1 is a block diagram showing an example configuration of an image forming apparatus.

FIG. 2 is a flowchart showing print control on a basis of job authorization information in Method 1.

FIG. 3 is a flowchart showing the print control on the basis of the job authorization information in (a).

FIG. 4 is a flowchart showing the print control on the basis of the job authorization information in (b).

FIG. 5 is a flowchart showing the print control on the basis of the job authorization information in (c).

### DETAILED DESCRIPTION OF THE EXEMPLARY EMBODIMENTS

Embodiments of the present disclosure will be described with reference to the drawings.

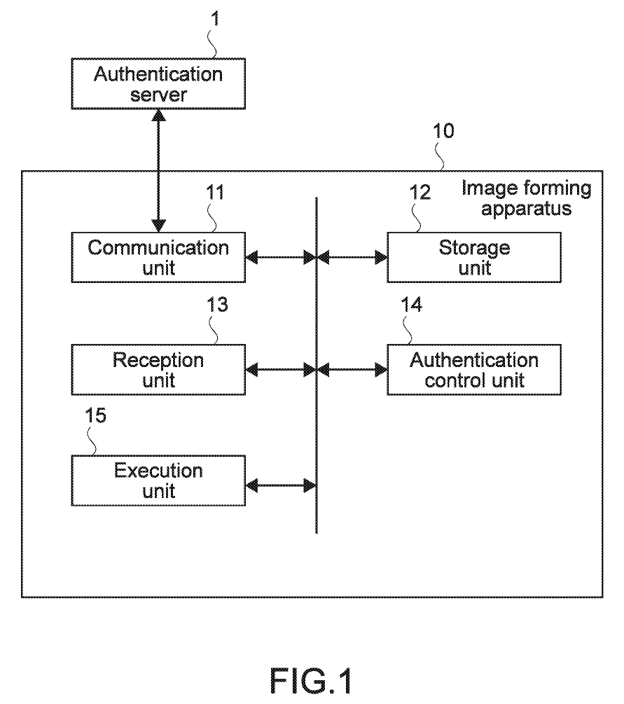

FIG. 1 is a block diagram showing an example configuration of an image forming apparatus 10 in this embodiment.

The image forming apparatus 10 performs printing received print data onto paper via a network. For example, the image forming apparatus 10 is a multifunction printer or a printer. In this embodiment, the image forming apparatus 10 has a storage unit 12 that stores a hot folder holding image data. The image forming apparatus 10 authorizes a job on a basis of job authorization information set for individual user information (e.g., user ID) for the image data input to the hot folder, and executes printing on the basis of that job authorization information.

For example, as shown in FIG. 1, the image forming apparatus 10 has a communication unit 11, a storage unit 12, a reception unit 13, an authentication control unit 14, and an execution unit 15.

The communication unit 11 performs data communication with an external apparatus including an authentication server 1 via the network. In this embodiment, the authentication server 1 and the image forming apparatus 10 are interconnected by the network. A communication method used by the communication unit 11 is not limited, and a known technology such as the Ethernet (registered trademark) may be used.

The authentication server 1 holds the job authorization information of the user who uses the image forming apparatus 10. Here, the job authorization information includes authorization whether or not a printing function such as print, color print, monochrome print, batch printing, or duplex printing can be used. For example, the job authorization information is set by each user, such as a user A authorized only for the monochrome print, or a user B not authorized for print (unable to use the printing function). The job authorization information is not limited to the above and may also include permission or restriction on a use of functions such as transmission or fax, the number of copies to print, a paper type (e.g., thick paper, thin paper, color paper), a paper size, copying, and a variety of information.

The storage unit 12 stores at least one hot folder. The hot folder associates a function that performs specific processing on data (image data, etc.) within the folder with a shared folder, enabling that specific processing to be performed on data stored in that shared folder. The storage unit 12 may also store a variety of information. For example, it may store the user ID that accesses the hot folder, print history, various settings, etc.

The reception unit 13 accepts a use of the image forming apparatus 10 by the user and an access to the hot folder stored in the storage unit 12 using the user information including the user ID for identifying at least a predetermined user. For example, the reception unit 13 may be configured of a liquid crystal panel and an overlaid touch panel. When the user inputs the user ID via the reception unit 13, a function of the image forming apparatus, such as printing can be used.

The user information may also include a variety of information, such as a password set for each user ID.

The authentication control unit 14 transmits the user information (e.g., the user ID) used when accessing the hot folder to the authentication server 1, requests authentication, and acquires the job authorization information authorized for the authenticated user.

For example, the authentication server 1 authenticates the user on the basis of the user ID and the password transmitted from the authentication control unit 14 and transmits the job authorization information authorized for the authenticated user. An authentication method is not limited and existing authentication methods such as Kerberos authentication or NTLM (NT LAN Manager authentication) may be used.

The execution unit 15 executes printing of a file (the image data, etc.) placed in the hot folder on the basis of the job authorization information acquired by the authentication control unit 14. Furthermore, when the job authorization information is not acquired, the execution unit 15 executes printing of the file placed in the hot folder on the basis of a system setting, or does not perform printing. Here, the system setting refers to a setting for the authorization information, such as printing or copying, associated with each group to which the user belongs on an MFP body.

The image forming apparatus 10 is not limited to the above configuration. For example, the communication unit 11 may be configured to communicate with a PC or the like operated by the user, and may receive the image data or an operation instruction from the PC. It may also include a display unit or the like to notify the user of abnormal conditions such as an error or a malfunction during printing.

Here, a flow in the related art where the user logs in the image forming apparatus using network authentication and uses the job authorization function will be described.

The user logs in the image forming apparatus via the authentication server. The authentication server performs the authentication on the basis of the entered user ID and the entered password. As the authentication method used by the authentication server, the Kerberos authentication, the NTLM authentication, etc. may be used.

When the authentication succeeds, the image forming apparatus acquires the user information from the authentication server (LDAP (Lightweight Directory Access Protocol)). The image forming apparatus then uses the acquired user information to authorize the job of the job authorization information. The user executes the authorized job (such as printing or copying).

That is, when the user logs in using the network authentication and performs the job authorization, the image forming apparatus performs the authentication as a client at the authentication server and then acquires the user information.

Next, a case of the hot folder in the related art is shown.

In the case of the Kerberos authentication, the image forming apparatus joins a domain on the authentication server at startup using a user ID and a password of an admin (administrator). The user logs in to the PC (Personal Computer) as the user of a network domain and acquires an authentication ticket.

When the user accesses the hot folder of the image forming apparatus, the user presents the acquired authentication ticket to the authentication server to acquire a service ticket for access. The image forming apparatus permits access to the hot folder on the basis of the acquired service ticket. The user places a file (image data) in the hot folder. This enables the image forming apparatus to print the file placed in the hot folder.

In the case of the NTLM authentication, the image forming apparatus joins the domain on the authentication server at startup using the user ID and the password of the admin (administrator). The user logs in the PC as a network domain user via the NTLM authentication. The user then accesses the hot folder of the image forming apparatus. At this time, the image forming apparatus delegates the user authentication to the authentication server using NTLM pass-through authentication.

When the user authentication is performed, the image forming apparatus permits the user to access the hot folder. The user places the file in the hot folder. Thus, the image forming apparatus prints the file placed in the hot folder.

In such a case of the hot folder, the image forming apparatus operates as the server and permits the access to the hot folder. However, the image forming apparatus can acquire the user ID when the user accesses the hot folder, but cannot acquire the password or other user information, and thus cannot acquire the job authorization information of the user.

Therefore, in this embodiment, two methods are performed to acquire the job authorization information.

### Method 1

In Method 1, in order to perform the job authorization, the user information (the job authorization information) is acquired and the job authorization is performed using the user ID and the password of the administrator user for a domain setting.

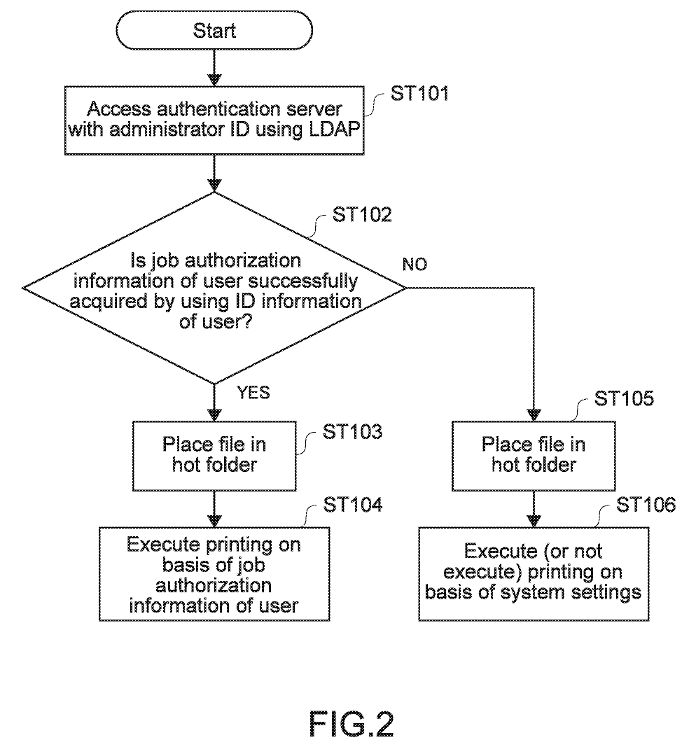

FIG. 2 is a flowchart showing print control based on the job authorization information in Method 1. Note that, in FIG. 2, the user is already in a state where the user can access the hot folder.

As shown in FIG. 2, since joining the domain is necessary for the authentication at the hot folder, the image forming apparatus 10 uses the user ID and the password of the admin (administrator) to join that domain and accesses the authentication server 1 using the LDAP (Step 101).

When the user accesses the hot folder, the user ID can be acquired from the authentication ticket. The authentication control unit 14 transmits the user information using the user ID and the password of the admin to the authentication server 1 when the user accesses the hot folder, and determines whether or not the user information (the job authorization information) of the user is successfully acquired (Step 102).

When the job authorization information of the user accessing the hot folder is successfully acquired (YES in Step 102), the execution unit 15 executes printing of the file placed in the hot folder by the user on the basis of the job authorization information of the user (Step 103, Step 104).

When the job authorization information of the user fails to be acquired (NO in Step 102), the execution unit 15 executes printing or does not execute printing of the file placed in the hot folder by the user on the basis of the system setting (Step 105, Step 106). For example, when the file that cannot be printed without authorization according to the system setting is placed in the hot folder, printing of the file is not executed.

### Method 2

In Method 2, the user information of the user who logged in using the network authentication is copied locally to the image forming apparatus 10, and the job authorization is performed using the user information.

For example, when the user logs in using the network authentication from a panel, etc., the user information of the user is copied internally (locally) to the image forming apparatus 10. Items copied differ depending on the authentication method. This embodiment illustrates the following three types, as examples.
(a) User ID and job authorization information
(b) User ID and password
(c) User ID and authentication ticket

The information is held within the image forming apparatus 10 (e.g., in the storage unit) only for a set holding period. The holding period for the information may be set arbitrarily. Furthermore, the items copied are not limited to the above (a), (b), and (c); various items may be copied and saved.

### a. User ID and Job Authorization Information

In (a), the user ID is acquired when the user accesses the hot folder. Specifically, for the Kerberos authentication, the user ID from the service ticket is acquired; for the NTLM authentication, the user ID at a time of access is acquired. The acquired user ID is used to acquire the copied job authorization information and perform the job authorization.

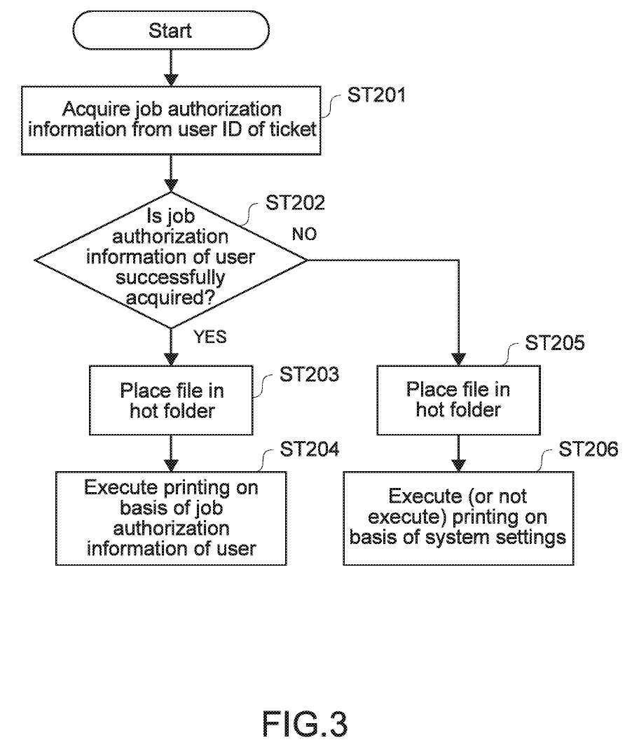

FIG. 3 is a flowchart showing the print control based on the job authorization information in (a). In FIG. 3, the user is in a state where the user can access the hot folder, and the user information of the user is copied to the image forming apparatus 10.

As shown in FIG. 3, the image forming apparatus 10 acquires the job authorization information from the user ID of the service ticket and determines whether or not the job authorization information of the user is successfully acquired (Step 201, Step 202).

When the job authorization information of the user accessing the hot folder is successfully acquired (YES in Step 202), the execution unit 15 executes printing of the file placed in the hot folder by the user on the basis of the job authorization information of the user (Step 203, Step 204).

When the job authorization information of the user fails to be acquired (NO in Step 202), the execution unit 15 executes printing or does not execute printing for the file placed in the hot folder by the user on the basis of system setting (Step 205, Step 206).

### b. User ID and Password

In (b), the user ID is acquired when the user accesses the hot folder. Specifically, for the Kerberos authentication, the user ID from the service ticket is acquired, or for the NTLM authentication, the user ID at the time of access is acquired. By acquiring the password from the acquired user ID, the authentication server is accessed to acquire the job authorization information of the user.

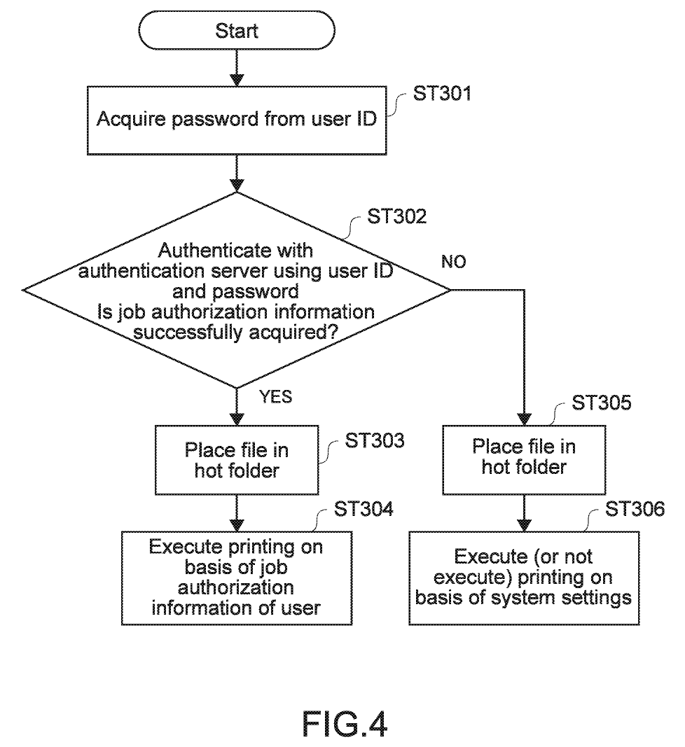

FIG. 4 is a flowchart showing the print control based on the job authorization information in (b). In FIG. 4, the user is in a state where the user can access the hot folder, and the user information of the user is copied to the image forming apparatus 10.

As shown in FIG. 4, the image forming apparatus 10 acquires the user password from the user ID (Step 301). The authentication control unit 14 transmits the user ID and the password to the authentication server 1, and requests the authentication to determine whether or not the job authorization information of the user is successfully acquired (Step 302).

When the job authorization information of the user accessing the hot folder is successfully acquired (YES in Step 302), the execution unit 15 executes printing of the file placed in the hot folder by the user on the basis of the job authorization information of the user (Step 303, Step 304).

When the job authorization information of the user fails to be acquired (NO in Step 302), the execution unit 15 executes printing or does not execute printing of the file placed in the hot folder by the user on the basis of the system setting (Step 305, Step 306).

### c. User ID and Authentication Ticket

In the (c), the Kerberos authentication is used. When the user accesses the hot folder, the user ID is acquired from the authentication ticket. The authentication ticket is then acquired from the acquired user ID, and user information (the job authorization information) is acquired using the authentication ticket.

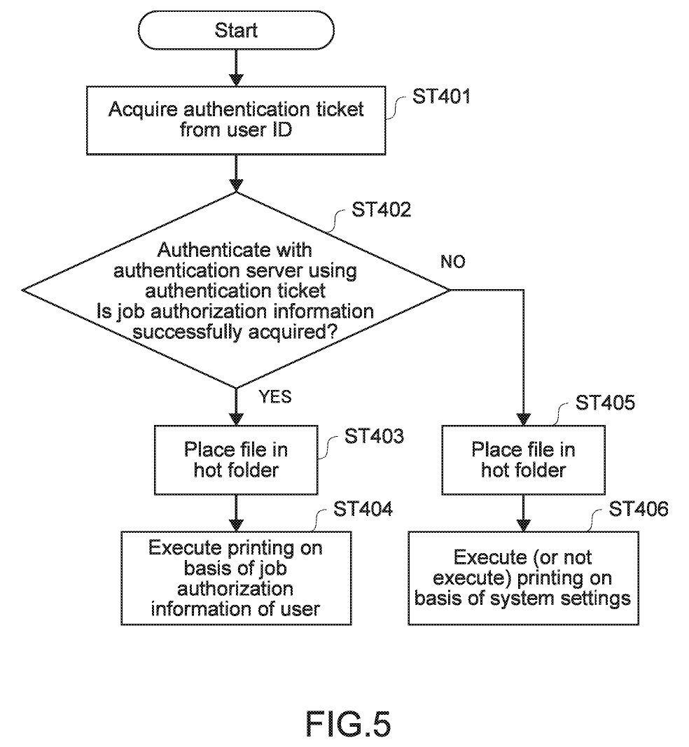

FIG. 5 is a flowchart showing the print control based on the job authorization information in (c). In FIG. 5, the user is in a state where the user can access the hot folder via the Kerberos authentication, and the user information of the user is copied to the image forming apparatus 10.

As shown in FIG. 5, the image forming apparatus 10 acquires the authorization ticket from the user ID (Step 401). The authentication control unit 14 determines whether or not the job authorization information is successfully acquired by using the acquired authentication ticket and authenticating with the authentication server (Step 402).

When the job authorization information of the user accessing the hot folder is successfully acquired (YES in Step 402), the execution unit 15 executes printing of the file placed in the hot folder by the user on the basis of the job authorization information of the user (Step 403, Step 404).

When the job authorization information of the user fails to be acquired (NO in Step 402), the execution unit 15 executes printing or does not execute printing for the file placed in the hot folder by the user on the basis of system setting (Step 405, Step 406).

According to this embodiment, the image forming apparatus 10 connected to the authentication server 1 via the network includes the storage unit 12 that stores at least one hot folder, the reception unit 13 that accepts the use of the image forming apparatus 10 by the user and the access to the hot folder using the user information including the user ID for identifying at least the predetermined user, and the authentication control unit 14 that transmits the user information used when accessing the hot folder to the authentication server 1, requests the authentication, and acquires the job authorization information that includes the authorization for at least the printing function of the image forming apparatus 10 for the authenticated user information. This enables the job authorization when using the image forming apparatus 10 as the server for printing via the Kerberos authentication or the like.

In the related art, when the user logs in using the network authentication and performs the job authorization, the Kerberos authentication or the NTLM authentication may be used. In this case, when accessing the hot folder that automatically executes predetermined processing upon data (e.g., the image data) being stored within the folder, the multifunction printer (MFP) can operate as the server and permit access to the hot folder. However, since the user information cannot be acquired, the job authorization information of the user cannot be acquired.

The present technology performs the job authorization using two methods: the administrator user for the domain setting is used, the user information is acquired, and the job authorization is performed, or the network authentication is copied locally, and the job authorization is performed using the copied user information. This enables the job authorization when using the image forming apparatus as the server for printing via the Kerberos authentication or the like. Furthermore, even if the NTLM authentication is discontinued, according to the present disclosure, since the Kerberos authentication is used, the job authorization information is acquired and a file transfer and reception function, such as exchanging files placed in the hot folder can be used.

Those skilled in the art will understand that various modifications, combinations, subcombinations, and alterations may be made within the scope of the appended claims or their equivalents, depending on design requirements and other factors.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus connected to an authentication server via a network, comprising:
a storage unit that stores at least one hot folder;
a reception unit that accepts a use of the image forming apparatus by a user and an access to the hot folder using user information including a user ID for identifying at least a predetermined user; and
an authentication control unit that transmits the user information used when accessing the hot folder to the authentication server, requests authentication, and acquires job authorization information that includes authorization for at least a printing function of the image forming apparatus for the authenticated user information.

2. The image forming apparatus according to claim 1, wherein the user is an administrator, and wherein the authentication control unit transmits user information of the administrator to the authentication server, requests authentication, and acquires job authorization information of the administrator.

3. The image forming apparatus according to claim 1, wherein the authentication control unit transmits the user information used to use the image forming apparatus to the authentication server, requests authentication, and acquires the job authorization information of the user information, and wherein the storage unit stores the user information used to use the image forming apparatus and the acquired job authorization information.

4. The image forming apparatus according to claim 1, wherein the user information includes a password of the user, wherein the storage unit stores a user ID of the user and a password of the user used to use the image forming apparatus, and wherein the authentication control unit transmits the stored user ID and the stored password to the authentication server, requests authentication, and acquires job authorization information of the user.

5. The image forming apparatus according to claim 1, wherein the user information includes an authentication ticket permitting a use of the printing function of the image forming apparatus, wherein the storage unit stores the user ID of the user and the authentication ticket used to use the image forming apparatus, and wherein the authentication control unit transmits the stored user ID and the stored authentication ticket to the authentication server, requests authentication, and acquires the job authorization.
